(19) United States
(12) Patent Application Publication
(10) Pub. No.: US 2008/0046159 A1
(43) Pub. Date: Feb. 21, 2008

(54) Single-Track Vehicle Comprising a Brake Control Unit

(76) Inventors: Mark Baijens, Offenbach (DE); Thomas Sticher, Darmstadt (DE); Oliver Huth, Kronberg (DE); Markus Ohly, Lich-Eberstadt (DE); Thomas Meurers, Eschborm (DE); Patrick Wischer, Schwalbach a. Ts. (DE)

Correspondence Address: RATNERPRESTIA, P O BOX 980, VALLEY FORGE, PA, 19482-0980, US

(21) Appl. No.: 10/593,606

(22) PCT Filed: Mar. 16, 2005
(86) PCT No.: PCT/EP05/51210

§ 371 Date: Jun. 12, 2007

(30) Foreign Application Priority Data
Mar. 23, 2004 (DE) 10 2004 014 176.2

(51) Int. Cl. B60T 8/32; B60K 31/02

(52) U.S. Cl. 701/93; 180/179; 701/110

(57) ABSTRACT

A single-track vehicle comprising a brake control unit, wherein the brake control unit includes a means for actively assisting the driver by means of an active variation or limitation of a vehicle speed or of a quantity derived therefrom, in particular vehicle acceleration.

This application is the U.S. national phase application of PCT International Application No. PCT/EP2005/051210, filed Mar. 16, 2005, which claims priority to German Patent Application No. DE 10 2004 014 176.2, filed Mar. 23, 2004.

### BACKGROUND OF THE INVENTION

1. Technical Field

The present invention relates to a single-track vehicle comprising a brake control unit.

2. Description of the Related Art

Cruise control systems adjust a predefined vehicle speed by means of an automatic brake intervention and/or intervention into the driving engine control. Cruise control systems are also known by the name of ACC (Adaptive Cruise Control, adaptive driving speed control), or ICC (Intelligent Cruise Control, intelligent driving speed control), or AICC (Autonomous Intelligent Cruise Control, autonomous intelligent driving speed control) .

### SUMMARY OF THE INVENTION

An object of the invention involves disclosing a single-track vehicle, which assists the vehicle operator in controlling the brakes and the driving engine of the vehicle.

The object is achieved by the invention in that the brake control unit includes a means for actively assisting the driver by means of an active variation or limitation of a vehicle speed or of a quantity derived therefrom, in particular vehicle acceleration.

The term ‘an active variation or limitation of a vehicle speed or of a quantity derived therefrom’ also includes a control until standstill of the vehicle or starting to drive away from vehicle standstill.

The term ‘single-track vehicle’ has a very broad meaning. It refers to all two-wheel vehicles, in particular motorcycles, but also single-track vehicles with a sidecar, such as motorcycles with and without sidecars, or other three-wheel vehicles with a front wheel and two rear wheels, such as a ‘Trike’.

The term ‘vehicle acceleration’ has a very broad meaning in the sense of the invention. It implies positive accelerations, hence, an increase in the vehicle speed. On the other hand, this term also covers negative accelerations, hence, a reduction of the vehicle speed (vehicle deceleration).

It is provided according to the invention that the brake control unit is equipped with a vehicle speed controller for adjusting a desired vehicle speed by means of an automatic intervention into brake control and/or driving engine control.

According to the invention, the brake control unit includes a vehicle acceleration controller for adjusting a desired vehicle acceleration by means of an automatic intervention into brake control and/or driving engine control.

A longitudinal controller is arranged according to the invention for the purpose of actuation of a vehicle acceleration controller according to desired vehicle acceleration, the current vehicle acceleration, the current driving engine torque, and the current brake pressure.

It is arranged by the invention that the means for the active driver assistance comprise a cruise control system such as an ACC system, ICC system, or AICC system.

Cruise control systems adjust a predefined vehicle speed by means of an automatic brake intervention and/or intervention into the driving engine control. Cruise control systems are also known by the name of ACC (Adaptive Cruise Control, adaptive driving speed control), or ICC (Intelligent Cruise Control, intelligent driving speed control), or AICC (Autonomous Intelligent Cruise Control, autonomous intelligent driving speed control) .

In addition to enhancing the comfort of the driver (assistance function), the adjustment of the defined vehicle acceleration serves especially for increasing the driving safety (accident avoidance) .

The invention provides that the means for the active driver assistance comprise a device for assisting the vehicle's drive-away and/or for assisting the vehicle hold.

Devices for the vehicle drive-away assistance are especially a driver assistance system or functions used to prevent the vehicle from rolling back after stop of the vehicle such as HAS (Hill Start Assist) or AVH (Active Vehicle Hold) .

These devices are favorably used for motorcycles with a sidecar or with three wheels (Trike). It is not necessary in this case that the driver himself or herself assists the vehicle in standstill.

In vehicles equipped with a parking brake, it is additionally possible to employ the assistance function DBF (Dynamic Brake Function) and DAR (Drive-Away Release). Devices for vehicle hold assistance are especially a driver assistance system or functions, in which active assistance is provided for the hold of the vehicle, such as AVH (Active Vehicle Hold). E.g. an extension of a parking support is feasible as regards a two-wheeled vehicle for assisting the driver. This action can be performed by the driver automatically or in conformity with requirements, e.g. by means of actuating an actuating device.

It is arranged for by the invention that the means for the active driver assistance includes a device for stop-and-go control.

Devices for the stop-and-go control such as AVS (Active Vehicle stop) permit an automatic brake intervention comfortable for the driver and/or intervention into the driving engine control in stop-and-go traffic situations and in city traffic. In addition, a special control is provided for traffic situations in a traffic jam. These devices are employed for motorcycles with a sidecar or three wheels (Trike).

These control devices are favorably provided as comfort functions within the limits of cruise control operations. They facilitate driving in a traffic jam because the driver's main object is only to concentrate on steering of the vehicle. In particular in the case of single-track vehicles (motorcycles), the automatic control is terminated when a minimum vehicle speed is not reached, in order that the driver can safely balance the single-track vehicle. This prevents overturning of the single-track vehicle.

According to the invention, the means for the active driver assistance is a device for the automatic conditioning of the brake system depending on the risk potential.

The term ‘conditioning’ especially implies prefilling of the wheel brakes. This means that the brakes are activated by a low, constant pressure requirement in order that clearances between brake disc and brake pad are overcome. The prefilling action is executed when a risk potential is considered to prevail, indicating that a major vehicle deceleration such as an emergency stop will be required shortly (RAB, Ready Alert Brake)

It is arranged by the invention that the means for the active driver assistance include a device for the automatic ‘braking to become dry’ of brake discs of the brake system.

The term ‘braking to become dry’ implies that the vehicle brakes are activated by a low constant pressure requirement in order to remove any fluid film (rain water) existing on the brake disc by application of the brake pad against the brake disc (RBS, Rain Brake Support). It is provided according to the invention that the means for the active driver assistance include a device for the automatic vehicle deceleration for stabilization of the vehicle.

The term ‘automatic vehicle deceleration for vehicle stabilization’ implies in particular the initial phase of braking of the vehicle when it is detected that the vehicle is cornering and exhibits excessive vehicle speed (UCL) , in order to prevent the vehicle from being carried off course when cornering.

### BRIEF DESCRIPTION OF THE DRAWINGS

The invention is explained in detail by making reference to three illustrations (FIGS. 1 to 3).

FIG. 1 is a schematic drawing depicting a driving situation of a vehicle without other traffic participants in close vicinity.

FIG. 2 is a schematic drawing depicting a driving situation of a single-track vehicle with a motor vehicle driving ahead in close vicinity.

FIG. 3 is a schematic drawing depicting a driving situation of a single-track vehicle in a stop-and-go situation with a motor vehicle driving ahead and a vehicle following in the rear.

### DETAILED DESCRIPTION OF THE PREFERRED EMBODIMENTS

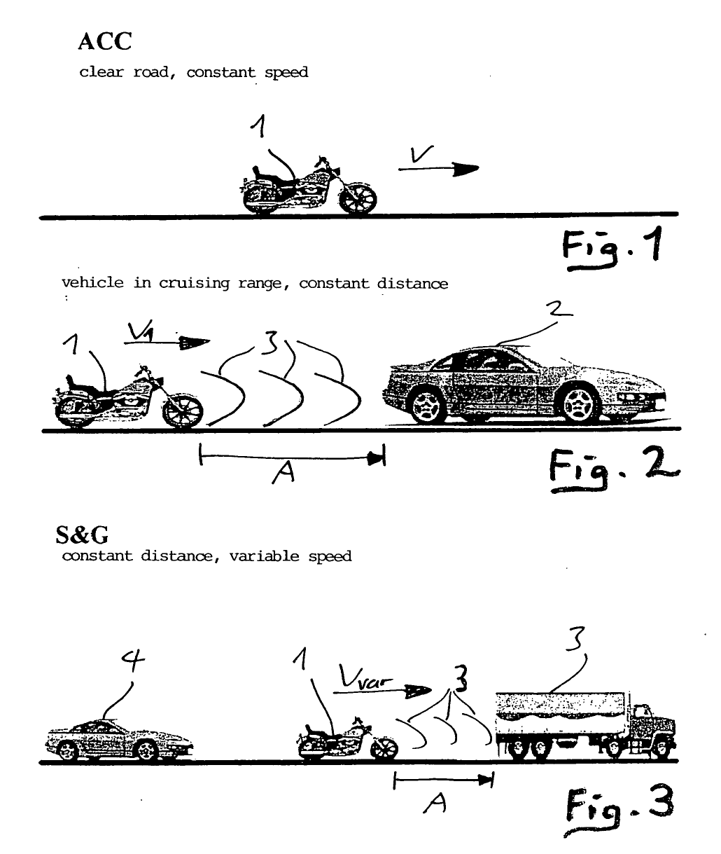

FIG. 1 shows a driving situation of a vehicle without other traffic participants in close vicinity.

The single-track vehicle 1 includes a brake control unit with a longitudinal controller, which determines a longitudinal acceleration demand internally or obtains it from an external unit, such as an ECU, herein e.g. an ACC system and a cruise control for a stop-and-go driving situation (stop-and-go system, S & G). The controller then calculates a corresponding pressure requirement for a brake system or a corresponding demand of an engine torque to an engine control system, depending on the instantaneous situation, such as acceleration demand, current acceleration, vehicle speed, or roadway. The brakes of the vehicle are controlled by setting the internal brake pressure requirement using a brake pressure controller, which controls a pressure source for hydraulic brake force boosting.

In this situation according to FIG. 1, the driver can be assisted by a cruise control function of the ACC system, that means an automatic vehicle speed control, in order to adjust and maintain a desired vehicle speed V without effort on the driver's part.

FIG. 2 shows a driving situation of the single-track vehicle 1 with a motor vehicle 2 driving ahead in close vicinity, which is detected by a sensor system using sensor signals 3.

In this situation, the driver can be assisted by a cruise control function, i.e. automatically maintaining a sufficient distance A from vehicle 2, and the vehicle speed VI of the vehicle 1 is automatically limited to preserve the distance A.

FIG. 3 illustrates a driving situation of the single-track vehicle 1 in a stop-and-go situation in which a motor vehicle 3 driving ahead and a vehicle 4 following in the rear are in the ambient field. The motor vehicle 3 driving ahead is detected by sensor signals 3. The driver is assisted in this situation in order to preserve a sufficient distance A from the vehicle 3 in that the vehicle speed Vvar is adjusted automatically in conformity with an optimal distance A by way of a corresponding pressure requirement to the brake system and/or a corresponding demand for an engine torque to the engine control system. Therefore, the vehicle 1 can be automatically accelerated or slowed down in this function. Thus, the driver is relieved in steering the vehicle, on the one hand, while a sufficient safety distance from vehicle 3 or 4 is preserved, on the other hand. This condition helps avoiding rear-end collisions.

1-10. (canceled)

11. Single-track vehicle comprising:
a brake control unit, including means for actively assisting a driver of the single-track vehicle by means of an active variation or limitation of a vehicle speed or of a quantity derived therefrom.

12. Single track vehicle as claimed in claim 11, wherein the quantity derived is acceleration.

13. Single-track vehicle as claimed in claim 11, wherein the brake control unit is equipped with a vehicle speed controller for adjusting a desired vehicle speed by means of an automatic intervention into brake control or driving engine control, or a combination thereof.

14. Single-track vehicle as claimed in claim 11, wherein the brake control unit includes a vehicle acceleration controller for adjusting a desired vehicle acceleration by means of an automatic intervention into brake control or driving engine control, or a combination thereof.

15. Single-track vehicle as claimed in claim 11, wherein the brake control unit comprises:
a vehicle acceleration controller; and
a longitudinal controller for actuating the vehicle acceleration controller according to a desired vehicle acceleration, a current vehicle acceleration, a current driving engine torque, and a current brake pressure.

16. Single-track vehicle as claimed in claim 11, wherein the means for actively assisting the driver comprise a cruise control system.

17. Single track vehicle as claimed in claim 16, wherein the cruise control system is selected from the group consisting of an adaptive cruise control system, an intelligent cruise control system and an autonomous intelligent cruise control system.

18. Single-track vehicle as claimed in claim 11, wherein the means for actively assisting the driver comprise a device for vehicle drive-away assistance or for vehicle hold assistance, or a combination thereof.

19. Single-track vehicle as claimed in claim 11, wherein the means for actively assisting the driver includes a device for stop-and-go control.

20. Single-track vehicle as claimed in claim 11, wherein the means for actively assisting the driver includes a device for automatically conditioning the brake system depending on a risk potential.

21. Single-track vehicle as claimed in claim 11, wherein the means for actively assisting the driver include a device for an automatic ‘braking to become dry’ of brake discs of the brake system.

22. Single-track vehicle as claimed in claim 11, wherein the means for actively assisting the driver include a device for automatic vehicle deceleration for stabilization of the vehicle.

23. Single-track vehicle system, comprising:
a single track vehicle; and
a brake control unit, including means for actively assisting the driver by means of an active variation or limitation of a vehicle speed or of a quantity derived therefrom.
